(19) United States
(12) Patent Application Publication
(10) Pub. No.: US 2025/0149721 A1
(43) Pub. Date: May 8, 2025

(54) Battery Pack, Electronic System, and Article of Personal Protective Equipment

(71) Applicant: 3M INNOVATIVE PROPERTIES COMPANY, St. Paul, MN (US)

(72) Inventors: Gaurav K. Gothoskar, Waxhaw, NC (US); John J. Yacobellis, Matthews, NC (US); Michael S. Meyer, Waxhaw, NC (US)

(21) Appl. No.: 18/837,495

(22) PCT Filed: Feb. 3, 2023
(86) PCT No.: PCT/IB2023/050975

§ 371 Date: Aug. 9, 2024

Related U.S. Application Data
(60) Provisional application No. 63/267,969, filed on Feb. 14, 2022.

(51) Int. Cl. H01M 50/264; A62B 9/04; H01M 10/42; H01M 10/48; H01M 50/247; H02J 7/00

(52) U.S. Cl. CPC H01M 50/264; A62B 9/04; H01M 10/425; H01M 10/48; H01M 50/247; H02J 7/0048

(57) ABSTRACT

A battery pack includes at least one electrochemical cell, a main housing, at least one projection, and a lock member. The main housing defines a longitudinal axis extending between front and rear surfaces, a transverse axis orthogonal to the longitudinal axis and extending between pair of lateral surfaces, a height axis extending between upper and lower surfaces and orthogonal to each of the longitudinal axis and the transverse axis, and a longitudinal plane of symmetry extending between the front surface and the rear surface and disposed parallel to each of the longitudinal axis and the height axis. The at least one projection is asymmetrically positioned with respect to the longitudinal plane of symmetry of the main housing. The lock member defines a lock slot therein extending along the transverse axis, such that the lock slot is asymmetrically positioned with respect to the longitudinal plane of symmetry of the main housing.

### TECHNICAL FIELD

The present disclosure relates to a battery pack, an electronic system including the battery pack, an article of personal protective equipment including the electronic system, and a method of using the electronic system.

### BACKGROUND

Articles of personal protective equipment (PPE) may be used by personnel (e.g., emergency responders) working in hazardous environments. In such hazardous environments, various electronic components may be required, for example, to generate telemetry data, alerts, etc., and/or communicate the same with other personnel or a central base station. Therefore, the articles of PPE may include an electronic module including the various electronic components. The electronic module may require one or more battery packs in order to provide electrical power to the various electronic components. However, assembling the one or more battery packs in the electronic module may be time-consuming and may cause delays. Further, current battery packs include electrochemical cells that may not be able to sustain charge while not in use, and/or may not have a long service life.

### SUMMARY

In a first aspect, the present disclosure provides a battery pack. The battery pack is configured to be removably received within a battery receptacle of an electronic module. The battery pack includes at least one electrochemical cell. The battery pack further includes a main housing receiving the at least one electrochemical cell therein. The main housing includes an upper surface, a lower surface opposite to the upper surface, a front surface extending between the upper surface and the lower surface, a rear surface opposite to the front surface and extending between the upper surface and the lower surface, and a pair of lateral surfaces opposite to each other and extending between the upper surface and the lower surface. Each of the lateral surfaces further extends between the front surface and the rear surface. The main housing defines a longitudinal axis extending between the front surface and the rear surface, a transverse axis orthogonal to the longitudinal axis and extending between the pair of lateral surfaces, a height axis extending between the upper surface and the lower surface and orthogonal to each of the longitudinal axis and the transverse axis, and a longitudinal plane of symmetry extending between the front surface and the rear surface and disposed parallel to each of the longitudinal axis and the height axis. The battery pack further includes at least one projection extending from the rear surface along the longitudinal axis. The at least one projection further extends along the transverse axis, such that the at least one projection is asymmetrically positioned with respect to the longitudinal plane of symmetry of the main housing. The at least one projection is configured to be at least partially received within a slot of the battery receptacle. The battery pack further includes a lock member disposed on the lower surface and extending from the front surface along the height axis. The lock member further extends along the longitudinal axis. The lock member defines a lock slot therein extending along the transverse axis, such that the lock slot is asymmetrically positioned with respect to the longitudinal plane of symmetry of the main housing. The lock slot is configured to at least partially receive a latch of the battery receptacle therein.

In a second aspect, the present disclosure provides an electronic system. The electronic system includes an electronic module including a battery receptacle. The battery receptacle includes a slot, a stationary member, and a latch rotatably coupled to the stationary member. The latch is rotatable relative to the stationary member between a locking position and an unlocking position. The electronic system further includes a battery pack configured to be removably received within the battery receptacle of the electronic module. The battery pack includes at least one electrochemical cell. The battery pack further includes a main housing receiving the at least one electrochemical cell therein. The main housing includes an upper surface, a lower surface opposite to the upper surface, a front surface extending between the upper surface and the lower surface, a rear surface opposite to the front surface and extending between the upper surface and the lower surface, and a pair of lateral surfaces opposite to each other and extending between the upper surface and the lower surface. Each of the lateral surfaces further extends between the front surface and the rear surface. The main housing defines a longitudinal axis extending between the front surface and the rear surface, a transverse axis orthogonal to the longitudinal axis and extending between the pair of lateral surfaces, a height axis extending between the upper surface and the lower surface and orthogonal to each of the longitudinal axis and the transverse axis, and a longitudinal plane of symmetry extending between the front surface and the rear surface and disposed parallel to each of the longitudinal axis and the height axis. The battery pack further includes at least one projection extending from the rear surface along the longitudinal axis, the at least one projection further extending along the transverse axis, such that the at least one projection is asymmetrically positioned with respect to the longitudinal plane of symmetry of the main housing. The at least one projection is configured to be at least partially received within the slot of the battery receptacle. The battery pack further includes a lock member disposed on the lower surface and extending from the front surface along the height axis. The lock member further extends along the longitudinal axis. The lock member defines a lock slot therein extending along the transverse axis, such that the lock slot is asymmetrically positioned with respect to the longitudinal plane of symmetry of the main housing. The lock slot is configured to at least partially receive the latch of the battery receptacle therein. In the unlocking position of the latch, the latch is disposed outside the lock slot of the lock member. In the locking position of the latch, the latch is at least partially received within the lock slot of the lock member, thereby securing the battery pack to the electronic module.

In a third aspect, the present disclosure provides an article of personal protective equipment (PPE). The article of PPE includes an air cylinder including breathable air, a back frame configured to support the air cylinder on a back of a user, a facemask arranged to provide the breathable air from the air cylinder to the user, a regulator in fluid communication with the air cylinder and configured to control a supply of the breathable air to the facemask, and the electronic system of the second aspect mounted on the back frame.

In a fourth aspect, the present disclosure provides a method of using the electronic system of the second aspect. The method includes tilting the battery pack to a tilted configuration relative to the battery receptacle, such that the front surface is tilted away from the battery receptacle; at least partially inserting the battery pack into the battery receptacle in the tilted configuration, such that the rear surface is at least partially received within the battery receptacle; at least partially inserting the at least one projection of the battery pack within the slot of the battery receptacle; moving the battery pack from the tilted configuration to an installed configuration relative to the battery receptacle, such that the front surface is at least partially received within the battery receptacle and the lock slot of the battery pack is aligned with the latch of the battery receptacle; and rotating the latch from the unlocking position to the locking position, such that the latch is at least partially received within the lock slot of the battery pack.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

Exemplary embodiments disclosed herein may be more completely understood in consideration of the following detailed description in connection with the following figures. The figures are not necessarily drawn to scale. In particular, thicknesses of certain layers in proportion to certain other items are exaggerated for ease of illustration and clarity purposes. Like numbers used in the figures refer to like components. However, it will be understood that the use of a number to refer to a component in a given figure is not intended to limit the component in another figure labeled with the same number.

FIG. 1 is a schematic perspective view of an article of personal protective equipment (PPE), according to an embodiment of the present disclosure;

FIG. 2 is a schematic perspective view of an electronic system, according to an embodiment of the present disclosure;

FIG. 3 is a schematic perspective view of an electronic module of the electronic system, according to an embodiment of the present disclosure;

FIG. 4 is a schematic partially exploded view of a battery pack of the electronic system, according to an embodiment of the present disclosure;

FIG. 5A is a schematic side perspective view of the battery pack, according to an embodiment of the present disclosure;

FIG. 5B is a schematic top view of the battery pack, according to an embodiment of the present disclosure;

FIG. 5C is a schematic bottom view of the battery pack, according to an embodiment of the present disclosure;

FIG. 5D is a schematic side view of the battery pack, according to an embodiment of the present disclosure;

FIG. 5E is a schematic front perspective view of the battery pack, according to an embodiment of the present disclosure;

FIG. 5F is a schematic rear perspective view of the battery pack, according to an embodiment of the present disclosure;

FIG. 6 is a schematic circuit diagram of an electric circuit of the battery pack, according to an embodiment of the present disclosure;

FIGS. 7A-7G are schematic views depicting various steps of using the electronic system, according to an embodiment of the present disclosure; and

FIG. 8 is a flowchart depicting various steps of a method of using the electronic system, according to an embodiment of the present disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

In the following disclosure, the following definitions are adopted.

As recited herein, all numbers should be considered modified by the term “about”. As used herein, “a,” “an,” “the,” “at least one,” and “one or more” are used interchangeably.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties).

The term “substantially”, unless otherwise specifically defined, means to a high degree of approximation (e.g., within +/−10% for quantifiable properties) but again without requiring absolute precision or a perfect match.

The term “about”, unless otherwise specifically defined, means to a high degree of approximation (e.g., within +/−5% for quantifiable properties) but again without requiring absolute precision or a perfect match.

Terms such as same, equal, uniform, constant, strictly, and the like, are understood to be within the usual tolerances or measuring error applicable to the particular circumstance rather than requiring absolute precision or a perfect match.

As used herein, the terms “first” and “second” are used as identifiers. Therefore, such terms should not be construed as limiting of this disclosure. The terms “first” and “second” when used in conjunction with a feature or an element can be interchanged throughout the embodiments of this disclosure.

As used herein, “at least one of A and B” should be understood to mean “only A, only B, or both A and B”.

Unless specified or limited otherwise, the terms “attached,” “connected,” and variations thereof, are used broadly and encompass both direct and indirect attachments, connections, and couplings.

As used herein, the term “configured to” and like is at least as restrictive as the term “adapted to” and requires actual design intention to perform the specified function rather than mere physical capability of performing such a function.

As used herein, the term “at least partially” refers to any percentage greater than 1%. In other words, the term “at least partially” refers to any amount of a whole. For example, “at least partially” may refer to a small portion, half, or a selected portion of a whole. In some examples, “at least partially” may refer to a whole amount. The term “partially” refers to any percentage less than 100%.

As used herein, the term “spaced apart” refers to elements that are disposed at a distance from one another. A plurality of elements spaced apart from each other means that adjacent elements from the plurality of elements are disposed at a distance from one another. A plurality of elements at least partially spaced apart from each other means that at least portions of adjacent elements from the plurality of elements are disposed at a distance from one another.

As used herein, the terms(s) “electrically connecting” and/or “electrically connected” refer to direct coupling between components and/or indirect coupling between components via one or more intervening electric components, such that an electric signal can be passed between the two components. As an example of indirect coupling, two components can be referred to as being electrically connected, even though they may have an intervening electric component between them which still allows an electric signal to pass from one component to the other component.

Such intervening components may comprise, but are not limited to, wires, traces on a circuit board, and/or another electrically conductive medium/component.

As used herein, the term “Integrated Circuit (IC)” refers to an electronic device comprising one or more electronic circuits including electronic components formed on a small piece of semiconductor material, which performs the same function as a larger circuit made from discrete components.

As used herein, the term “pins” refers to terminals of an IC that interconnect analog components and circuitry within the IC to other components and wires in a circuit. The pins carry electrical signals in and out of the IC to allow it to function in a system.

As used herein, the term “electrochemical cell” refers to an electrochemical storage device that converts stored chemical energy into electrical energy. An electrochemical cell may be charged by a charging circuit that is controlled by a controller and may provide electrical energy to one or more components.

As used herein, the phrase “health of an electrochemical cell” refers to an amount of energy that the electrochemical cells are able to store and deliver in the full range of use cases, including higher or lower temperature or higher or lower current draw. For example, the health of an electrochemical cell includes electrochemical cell capacity, its voltage as a function of capacity, and its impedance across the useful voltage range.

As used herein, the phrase “age of an electrochemical cell” refers to an amount of time since the electrochemical cell was manufactured.

As used herein, the term “electrochemical cell capacity” refers to a measure (typically in amp-hr) of a charge stored by an electrochemical cell. The electrochemical cell capacity may represent a maximum amount of capacity that can be extracted from the electrochemical cell under certain specified conditions.

As used herein, the term “hazardous or potentially hazardous environmental conditions” may refer to environmental conditions that may be harmful to a human being, such as high noise levels, high ambient temperatures, lack of oxygen, presence of explosives, exposure to radioactive or biologically harmful materials, and exposure to other hazardous substances. Depending upon the type of safety equipment, environmental conditions and physiological conditions, corresponding thresholds or levels may be established to help define hazardous and potentially hazardous environmental conditions.

As used herein, the term “hazardous or potentially hazardous environments” may refer to environments that include hazardous or potentially hazardous environmental conditions. The hazardous or potentially hazardous environments may include, for example, chemical environments, biological environments, nuclear environments, fires, industrial sites, construction sites, agricultural sites, mining sites, or manufacturing sites.

As used herein, the term “an article of personal protective equipment (PPE)” may include any type of equipment or clothing that may be used to protect a user from hazardous or potentially hazardous environmental conditions. In some examples, one or more individuals, such as the users, may utilize the article of PPE while engaging in tasks or activities within the hazardous or potentially hazardous environment. Examples of the articles of PPE may include, but are not limited to, hearing protection (including ear plugs and ear muffs), respiratory protection equipment (including disposable respirators, reusable respirators, powered air purifying respirators, self-contained breathing apparatus and supplied air respirators), facemasks, oxygen tanks, air bottles, protective eyewear, such as visors, goggles, filters or shields (any of which may include augmented reality functionality), protective headwear, such as hard hats, hoods or helmets, protective shoes, protective gloves, other protective clothing, such as coveralls, aprons, coat, vest, suits, boots and/or gloves, protective articles, such as sensors, safety tools, detectors, global positioning devices, mining cap lamps, fall protection harnesses, exoskeletons, self-retracting lifelines, heating and cooling systems, gas detectors, and any other suitable gear configured to protect the users from injury. The articles of PPE may also include any other type of clothing or device/equipment that may be worn or used by the users to protect against extreme noise levels, extreme temperatures, fire, reduced oxygen levels, explosions, reduced atmospheric pressure, radioactive, and/or biologically harmful materials.

Articles of personal protective equipment (PPE) may be used by personnel (e.g., emergency responders) working in hazardous environments. In such hazardous environments, various electronic components may be required, for example, to generate telemetry data, alerts, etc., and/or and communicate the same with other personnel or a central base station. Therefore, the articles of PPE may include an electronic module including the various electronic components. The electronic module may use conventional battery packs in order to provide power to the various electronic components.

The conventional battery packs are symmetrical and therefore, the personnel using the article of PPE may have to carefully observe the battery pack prior to its installation in the electronic module. This may be time-consuming and may cause a delay in the installation of the conventional battery pack in the electronic module. Further, the conventional battery packs include electrochemical cells that may not be able to sustain charge while not in use, and/or may not have a long service life.

The present disclosure relates to a battery pack, an electronic system including the battery pack, an article of personal protective equipment including the electronic system, and a method of using the electronic system.

The battery pack of the present disclosure is configured to be removably received within a battery receptacle of an electronic module. The battery pack includes at least one electrochemical cell. The battery pack further includes a main housing receiving the at least one electrochemical cell therein. The main housing includes an upper surface, a lower surface opposite to the upper surface, a front surface extending between the upper surface and the lower surface, a rear surface opposite to the front surface and extending between the upper surface and the lower surface, and a pair of lateral surfaces opposite to each other and extending between the upper surface and the lower surface. Each of the lateral surfaces further extends between the front surface and the rear surface. The main housing defines a longitudinal axis extending between the front surface and the rear surface, a transverse axis orthogonal to the longitudinal axis and extending between the pair of lateral surfaces, a height axis extending between the upper surface and the lower surface and orthogonal to each of the longitudinal axis and the transverse axis, and a longitudinal plane of symmetry extending between the front surface and the rear surface and disposed parallel to each of the longitudinal axis and the height axis. The battery pack further includes at least one projection extending from the rear surface along the longitudinal axis. The at least one projection further extends along the transverse axis, such that the at least one projection is asymmetrically positioned with respect to the longitudinal plane of symmetry of the main housing. The at least one projection is configured to be at least partially received within a slot of the battery receptacle. The battery pack further includes a lock member disposed on the lower surface and extending from the front surface along the height axis. The lock member further extends along the longitudinal axis. The lock member defines a lock slot therein extending along the transverse axis, such that the lock slot is asymmetrically positioned with respect to the longitudinal plane of symmetry of the main housing. The lock slot is configured to at least partially receive a latch of the battery receptacle therein.

Since the battery pack of the present disclosure includes the at least one projection and the lock member asymmetrically positioned with respect to the longitudinal plane of symmetry of the main housing, the battery pack of the present disclosure may be installed in the battery receptacle only in an intended direction and position. This may ensure that the battery pack is installed in a correct manner. Further, the personnel using the article of PPE may easily identify the intended direction and position to install the battery pack in the battery receptacle, and therefore install the battery pack in the battery receptacle in less time than a time required to install the conventional battery packs. In some cases, asymmetrical features, i.e., the at least one projection and the lock member may also prevent installation of the battery pack in an incorrect manner.

Additionally, the battery pack of the present disclosure may include an electric circuit that may prevent the excessive thermal energy conditions in the battery pack.

Moreover, the at least one projection and the lock member may also ensure that the battery pack is secured in the battery receptacle of the electronic module, such that the battery pack may not be accidently removed from the battery receptacle and a tool is required for removal of the battery pack from the battery receptacle of the electronic module.

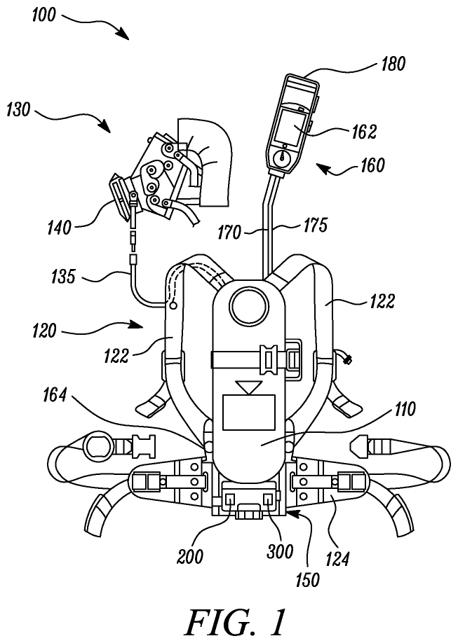

Referring now to the figures, FIG. 1 is a schematic perspective view of an article of personal protective equipment (PPE) 100, according to an embodiment of the present disclosure. The article of PPE 100 may interchangeably be referred to as “the article 100”. In some embodiments, the article 100 may be used by a user (not shown) in an environment, such as a hazardous or potentially hazardous environment. In some examples, the user of the article 100 may be any emergency personnel, such as a firefighter, a first responder, a healthcare professional, a paramedic, a HAZMAT worker, security personnel, law enforcement personnel, or any other personnel working in the environment. In the cases where the user is a firefighter, the article 100 may be worn by the firefighter in the environment. In some embodiments, the article 100 may include a breathing apparatus.

In the illustrated embodiment of FIG. 1, the article 100 includes a self-contained breathing apparatus (SCBA). The article 100 includes an air cylinder 110 including breathable air. The breathable air may include pressurized breathable air. The article 100 further includes a back frame 120 configured to support the air cylinder 110 on a back of the user. The air cylinder 110 may be mounted on the back frame 120. In some embodiments, the back frame 120 includes shoulder straps 122 and a belt 124, that are wearable by the user.

The article 100 further includes a facemask 130 arranged to provide the breathable air from the air cylinder 110 to the user. The article 100 further includes a regulator 140 in fluid communication with the air cylinder 110 and configured to control a supply of the breathable air to the facemask 130. In some embodiments, the regulator 140 is configured to be detachably mounted to the facemask 130. In some embodiments, the regulator 140 includes one or more valves (not shown) configured to control the supply of the breathable air to the facemask 130. In some embodiments, the article 100 may include an air line/data line 135, which supplies the breathable air from the air cylinder 110 to the regulator 140 and provides data communications and power supply to the regulator 140.

FIG. 1 further illustrates a schematic block representation of an electronic system 150. The electronic system 150 includes an electronic module 200 and a battery pack 300. In some embodiments, one or more components (not shown) of the electronic module 200 may be electrically connected to the battery pack 300 to receive power supply from the battery pack 300. The one or more components of the electronic module 200 may include one or more processors, one or more sensors, one or more communication devices, and so forth. In some embodiments, the one or more processors may include any suitable data processor for processing data. For example, the one or more processors may include a microprocessor, a microcontroller, a computer, or other suitable devices that control operation of devices and execute programs. Various other examples of the one or more processors include central processing units (“CPUs”), microcontrollers, programmable logic devices, field programmable gate arrays, digital signal processing (“DSP”) devices, and the like. The one or more processors may include any general variety device such as a reduced instruction set computing (“RISC”) device, a complex instruction set computing (“CISC”) device, or a specially designed processing device, such as an application-specific integrated circuit (“ASIC”) device.

In some embodiments, the electronic system 150 is mounted on the back frame 120. In the illustrated embodiment of FIG. 1, the electronic system 150 is disposed at a base of the air cylinder 110, on the belt 124. However, in some other embodiments, the electronic system 150 may be disposed at any location on the article 100, for example, on any one of the shoulder straps 122. In some embodiments, the air line/data line 135 may be communicably and/or electrically coupled to the one or more components of the electronic module 200. In some embodiments, the air line/data 30 line 135 may further be electrically connected to the battery pack 300 to provide the power supply to the regulator 140.

In some embodiments, the article 100 may further include a headgear (not shown) to provide protection to the head of the user. In some embodiments, the headgear may include one or more electronic components communicably and/or electrically connected to the one or more components of the electronic module 200 of the electronic system 150. The headgear may include safety goggles, a safety hat, or combinations thereof. The headgear may further include a heads-up display (HUD). The HUD may display one or more parameters to the user of the article 100. The one or more parameters may include parameters associated with a state of health of the article 100, parameters associated with the environment of the article 100, or a combination thereof. In some embodiments, the one or more components of the electronic module 200 may be configured to determine the one or more parameters.

In some embodiments, the parameters associated with the state of health of the article 100 may include a remaining level of air in the air cylinder 110, a battery level of the battery pack 300 of the article 100, and the like. In some embodiments, the parameters associated with the environment of the article 100 may include a temperature of the environment, a level of smoke or dust in the environment, a level of any gases in the environment, a location of other emergency personnel in the environment, and the like. In some embodiments, the HUD may display a notification including instructions and/or information received from a command gateway (not shown), and/or from other portable devices (not shown). The remaining level of air in the air cylinder 110 may be ascertained via a pressure sensor (not shown) located at an outlet pathway of the air cylinder 110 and communicably and/or electrically connected to the one or more components of the electronic module 200. The headgear may further include a hearing device (not shown). In some examples, the hearing device may include a wired/wireless headphone and/or an earphone communicably and/or electrically coupled to the electronic module 200 of the electronic system 150. In some other examples, the hearing device may include a hearing protection device, such as, a pair of earmuffs. In some embodiments, the air line/data line 135 provides data communications and power supply to the HUD via the electronic module 200 and the battery pack 300 of the electronic system 150, respectively.

In some embodiments, the article 100 further includes a personal alert safety system (PASS) device 160. The PASS device 160 may include a PASS control console 162 and an alert unit 164. The PASS control console 162 may hang from an end of a pressure data line 170, connected via a pressure reducer (not shown) to the air cylinder 110, and a reinforced cable sheath 175. The alert unit 164 may be carried in a recess in the back frame 120. Therefore, in the illustrated embodiment of FIG. 1, the PASS device 160 is shown to be distributed at two locations on the article 100-at the end of the reinforced cable sheath 175, and in the recess of the back frame 120. The article 100 may further include a personal digital assistance (PDA) device 180. The PDA device 180 may be located on the PASS device 160.

In some embodiments, the PASS device 160 is communicably and/or electrically connected to the electronic system 150. In some embodiments, the PASS device 160 may be communicably and/or electrically connected to electronic module 200 and may be powered by the battery pack 300. In some embodiments, the reinforced cable sheath 175 carries electronic cables that connect the electronic system 150 and the PASS device 160.

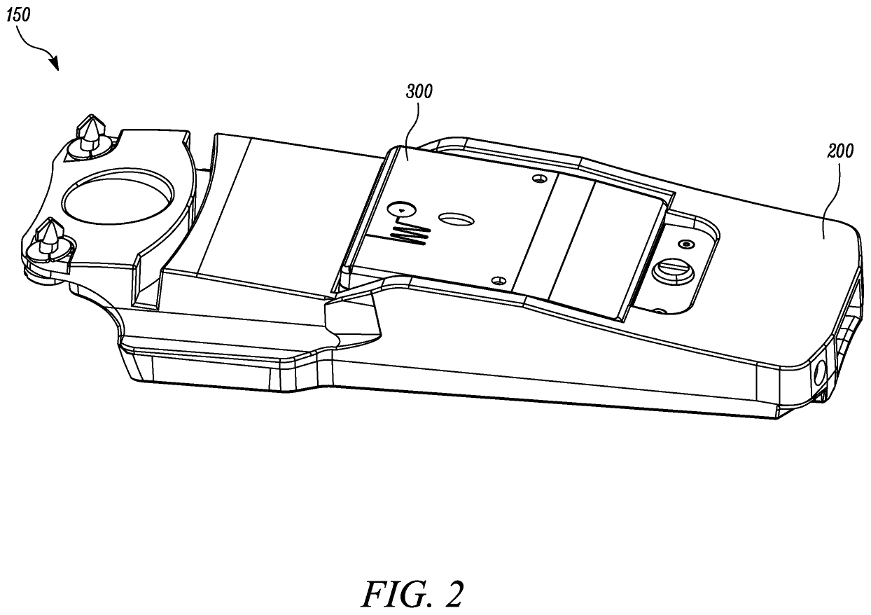

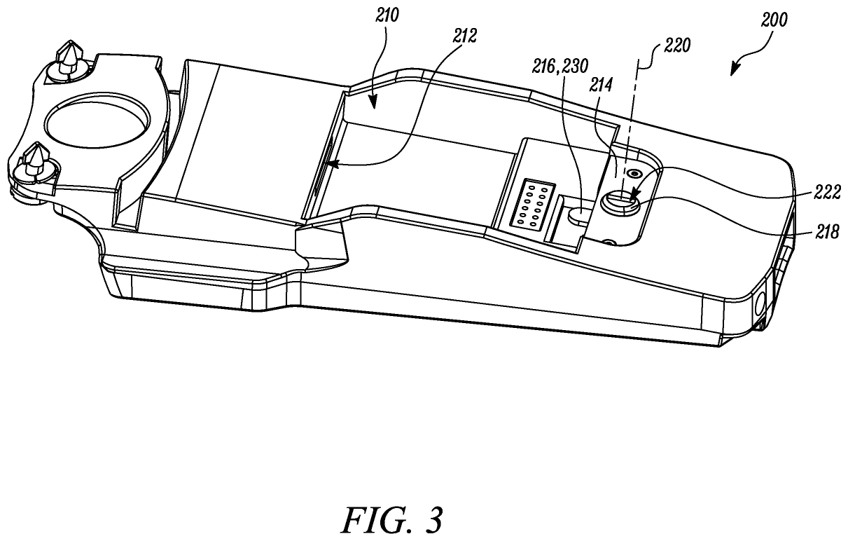

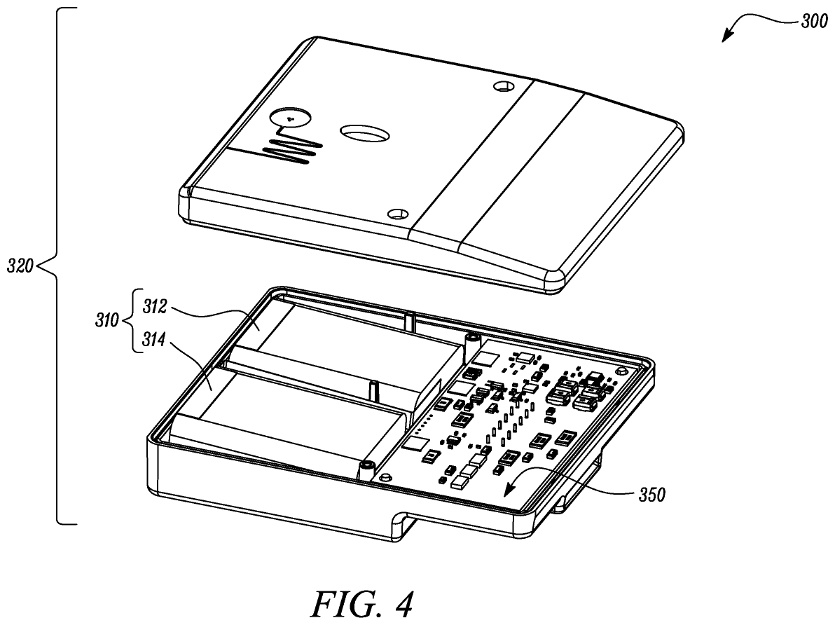

FIG. 2 is a schematic perspective view of the electronic system 150, according to an embodiment of the present disclosure. As discussed above, the electronic system 150 includes the electronic module 200 and the battery pack 300. The electronic module 200 is described in detail with reference to FIG. 3 below. The battery pack 300 is described in detail with reference to FIGS. 4 to 6 below.

FIG. 3 is a schematic perspective view of the electronic module 200 of the electronic system 150 shown in FIG. 2, according to an embodiment of the present disclosure.

The electronic module 200 includes a battery receptacle 210. The battery receptacle 210 includes a slot 212. The battery receptacle 210 further includes a stationary member 214 and a latch 216 rotatably coupled to the stationary member 214. In some embodiments, the stationary member 214 may be integral with (or made together with) the battery receptacle 210.

In some embodiments, the battery receptacle 210 further includes a rotatable member 218 rotatably coupling the latch 216 to the stationary member 214. In some embodiments, the rotatable member 218 includes at least one tool groove 222 configured to engage with a tool. A shape of the at least one tool groove 222 may be at least partially similar to a shape of a part of the tool with which the at least one tool groove 222 may engage. For example, in the illustrated embodiment of FIG. 3, the at least one tool groove 222 is a slot, therefore, a flat head screwdriver may be used to engage with the at least one tool groove 222.

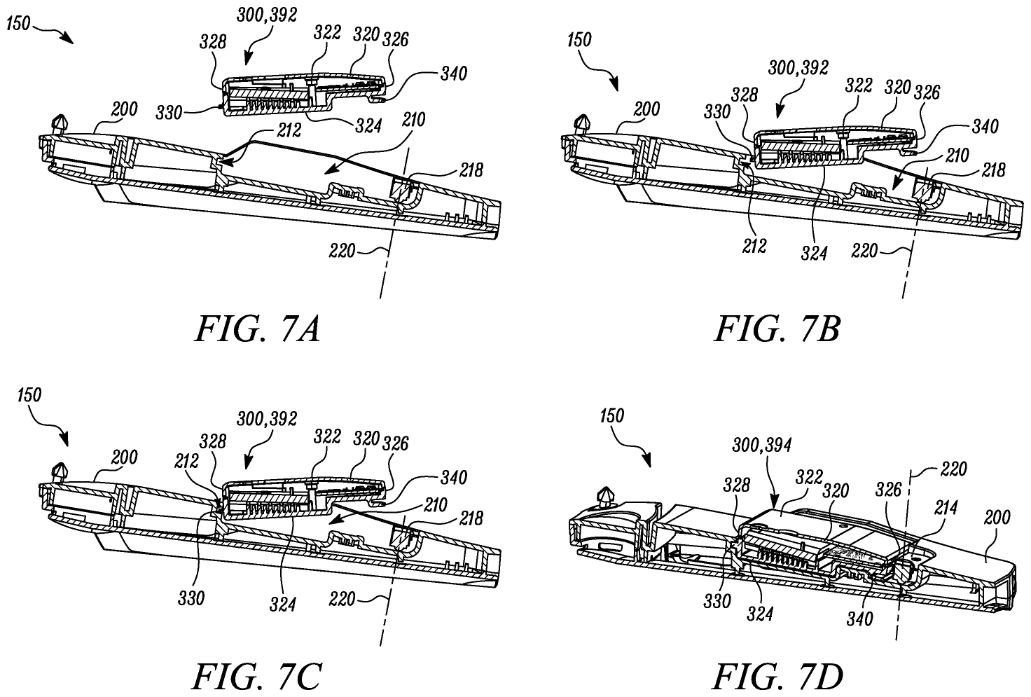

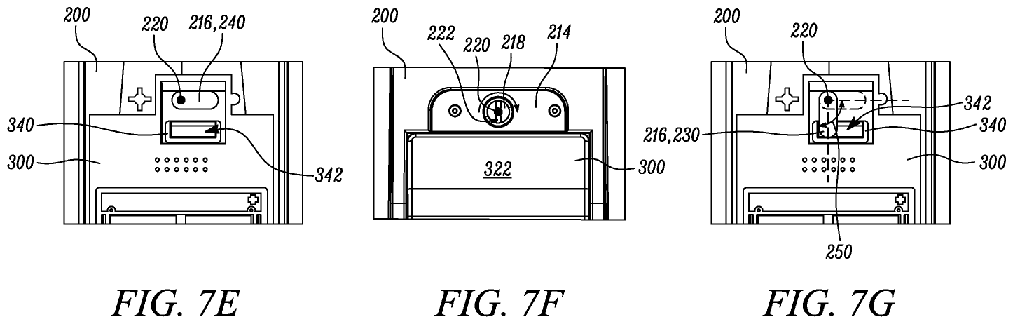

The latch 216 is rotatable relative to the stationary member 214 between a locking position 230 and an unlocking position 240 (shown in FIG. 7E). In some embodiments, the latch 216 is rotatable about a latch axis 220 normal to the stationary member 214 between the locking position 230 and the unlocking position 240. In some embodiments, a rotation angle 250 (shown in FIG. 7G) between the locking position 230 and the unlocking position 240 is about 90 degrees. In some embodiments, the rotation angle 250 is between about 80 degrees and about 100 degrees.

FIG. 4 is a schematic partially exploded view of the battery pack 300 of the electronic system 150 shown in FIG. 2, according to an embodiment of the present disclosure. The battery pack 300 is configured to be removably received within the battery receptacle 210 of the electronic module 200 shown in FIG. 3.

The battery pack 300 includes at least one electrochemical cell 310. In the illustrated embodiment of FIG. 4, the at least one electrochemical cell 310 includes a pair of electrochemical cells 312, 314. However, in some other embodiments, the at least one electrochemical cell 310 may include any number of electrochemical cells, as per desired application attributes. In some examples, the at least one electrochemical cell 310 may be rechargeable, i.e., the at least one electrochemical cell 310 may be at least one secondary electrochemical cell. In some other examples, the at least one electrochemical cell 310 may not be rechargeable, i.e., the at least one electrochemical cell 310 may be at least one primary electrochemical cell.

Further, in the illustrated embodiment of FIG. 4, the at least one electrochemical cell 310 includes prismatic cells. In some embodiments, the at least one electrochemical cell 310 may include Molicel ICP103450DA commercially available from E-One Moli Energy Canada Ltd., Vancouver, BC.

The prismatic cells may be able to sustain charge while not in use and an age of the prismatic cells may be longer than other conventional cells. Further, the prismatic cells may provide a compact source of power. However, in some other embodiments, the at least one electrochemical cell 310 may include coin cells, cylindrical cells, or any other electrochemical cells, as per desired application attributes. In some embodiments, the at least one electrochemical cell 310 may include Lithium-Ion cells, nickel-cadmium (NiCd) cells, nickel metal hydride (NiMH) cells, and the like. In some embodiments, the at least one electrochemical cell 310 may include alkaline cells.

In some embodiments, the at least one electrochemical cell 310 may have a Temperature Class or T-Class of T4. In other words, a surface temperature of the at least one electrochemical cell 310 may not exceed 135 degrees Celsius (° C.) in a fault condition. In some embodiments, the at least one electrochemical cell 310 may have the rating of T5 or T6, i.e., the surface temperature of the at least one electrochemical cell 310 may not exceed 100° C. or 85° C., respectively in the fault condition. The T-Class of the at least one electrochemical cell 310 may be chosen based on the desired application attributes and/or the environment in which the battery pack 300 may be used.

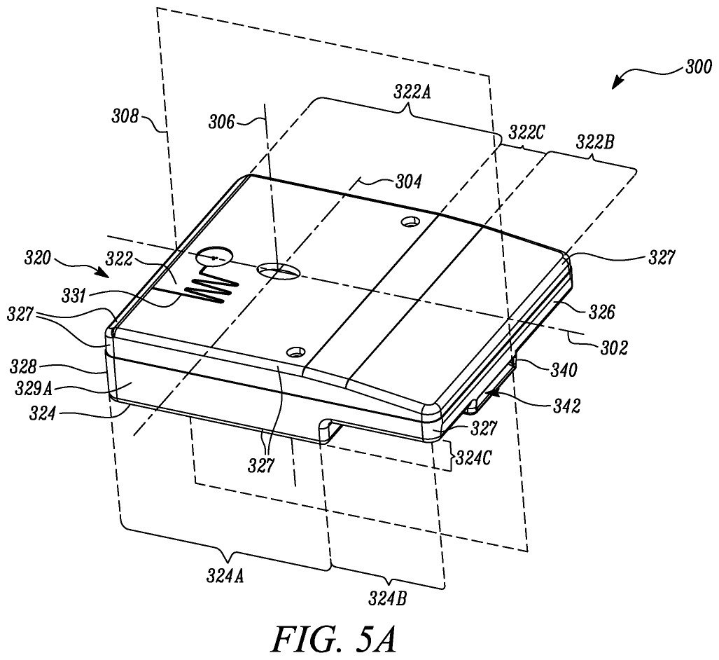

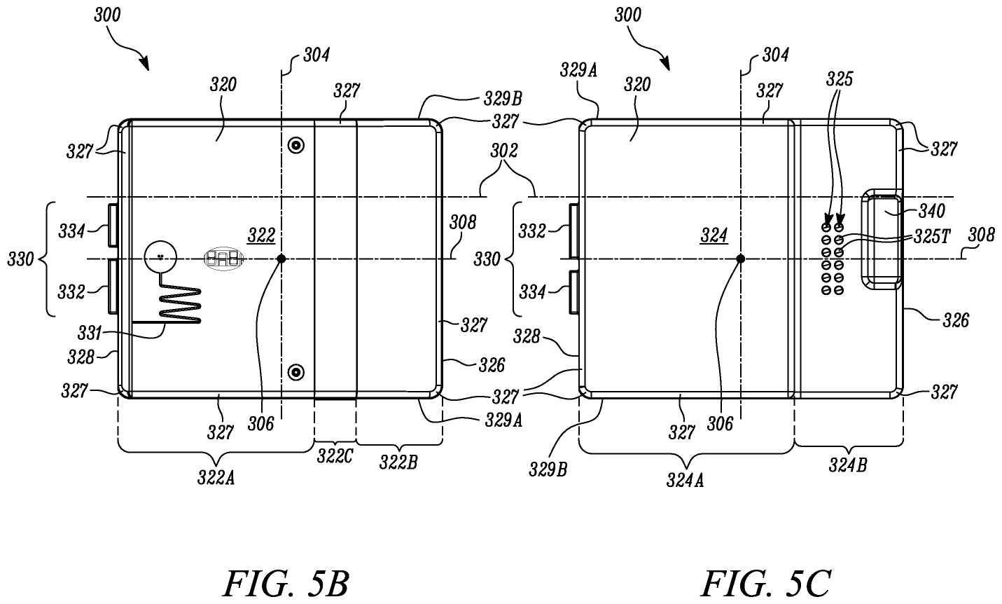

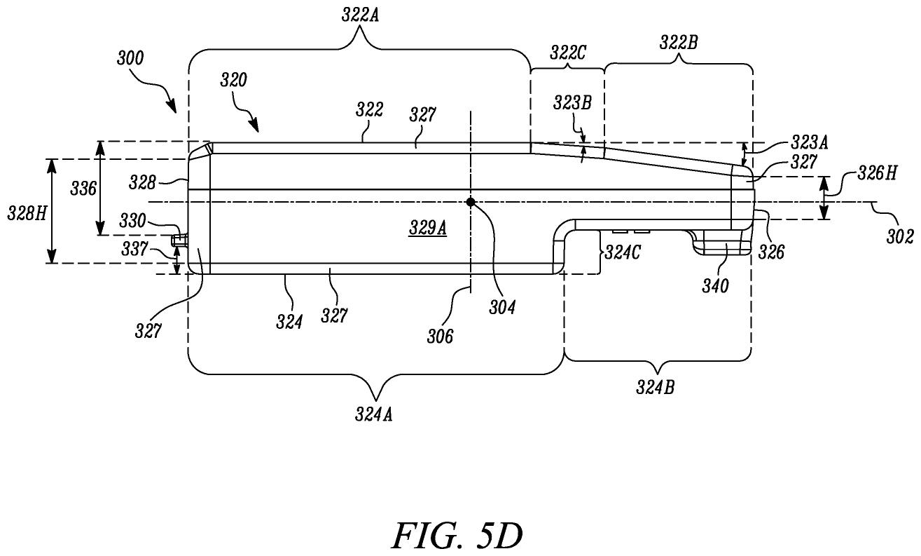

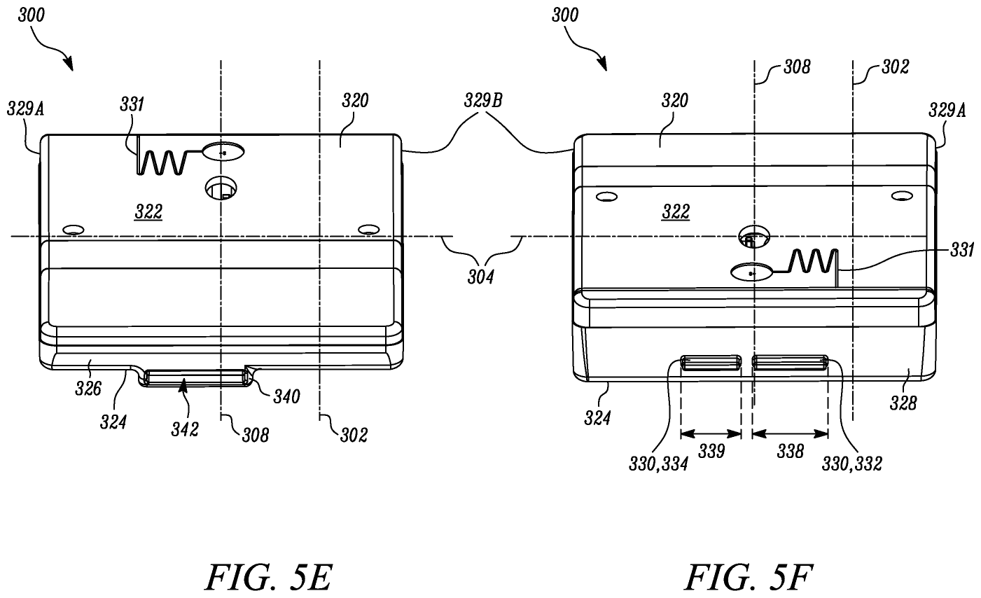

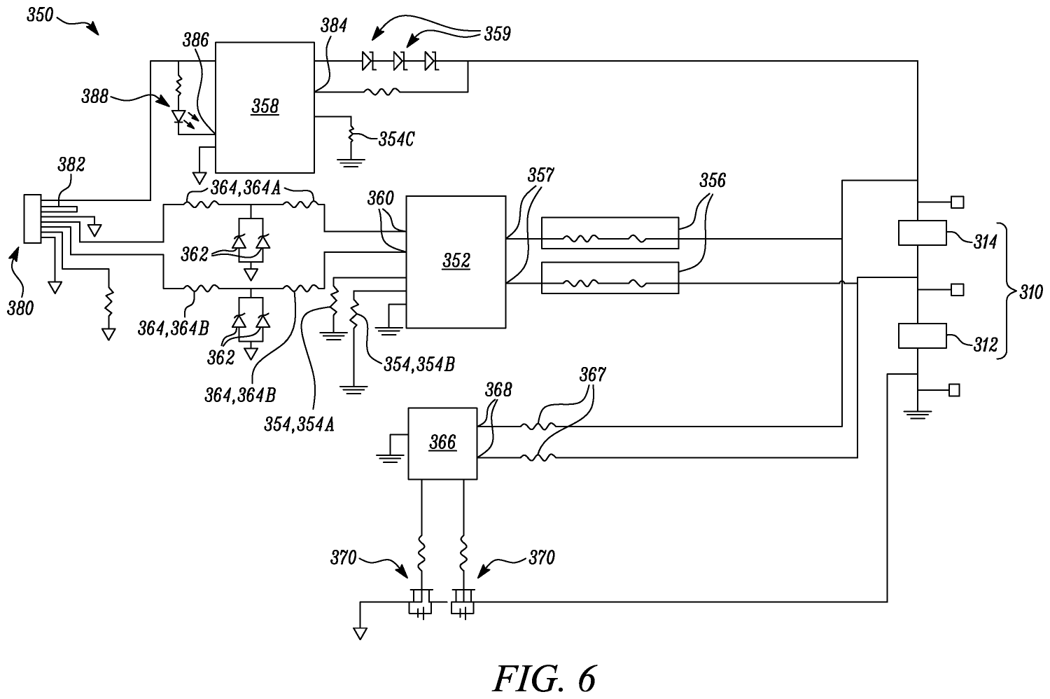

The battery pack 300 further includes a main housing 320 receiving the at least one electrochemical cell 310 therein. In some embodiments, the battery pack 300 further includes an electric circuit 350 received within the main housing 320. The main housing 320 is described in detail with reference to FIGS. 5A-5F below. The electric circuit 350 is described in detail with reference to FIG. 6 below.

FIG. 5A is a schematic side perspective view of the battery pack 300, according to an embodiment of the present disclosure. FIG. 5B is a schematic top view of the battery pack 300, according to an embodiment of the present disclosure. FIG. 5C is a schematic bottom view of the battery pack 300, according to an embodiment of the present disclosure. FIG. 5D is a schematic side view of the battery pack 300, according to an embodiment of the present disclosure. FIG. 5E is a schematic front perspective view of the battery pack 300, according to an embodiment of the present disclosure. FIG. 5F is a schematic rear perspective view of the battery pack 300, according to an embodiment of the present disclosure. Some internal components of the battery pack 300 received within the main housing 320 are not visible in FIGS. 5A-5F.

Referring to FIGS. 5A-5F, the main housing 320 includes an upper surface 322 and a lower surface 324 opposite to the upper surface 322. The main housing 320 further includes a front surface 326 extending between the upper surface 322 and the lower surface 324, and a rear surface 328 opposite to the front surface 326 and extending between the upper surface 322 and the lower surface 324. The main housing 320 further includes and a pair of lateral surfaces 329A, 329B opposite to each other and extending between the upper surface 322 and the lower surface 324. Each of the lateral surfaces 329A, 329B further extends between the front surface 326 and the rear surface 328. In some embodiments, the upper surface 322, the lower surface 324, the front surface 326, the rear surface 328, and the pair of lateral surfaces 329A, 329B include an electrically insulative material. For example, the electrically insulative material may include any polymeric material.

The main housing 320 defines a longitudinal axis 302 extending between the front surface 326 and the rear surface 328, a transverse axis 304 orthogonal to the longitudinal axis 302 and extending between the pair of lateral surfaces 329A, 329B, and a height axis 306 extending between the upper surface 322 and the lower surface 324 and orthogonal to each of the longitudinal axis 302 and the transverse axis 304.

The main housing 320 further defines a longitudinal plane of symmetry 308 extending between the front surface 326 and the rear surface 328 and disposed parallel to each of the longitudinal axis 302 and the height axis 306. The transverse axis 304 is therefore orthogonal to the longitudinal plane of symmetry 308.

In some embodiments, the main housing 320 further includes a plurality of rounded edge surfaces 327. For example, the rounded edge surfaces 327 may extend between and connect the upper surface 322 and each of the pair of lateral surfaces 329A, 329B, the upper surface 322 and the front surface 326, and the upper surface 322 and the rear surface 328. Similarly, the rounded edge surfaces 327 may extend between and connect the lower surface 324 and each of the pair of lateral surfaces 329A, 329B, the lower surface 324 and the front surface 326, and the lower surface 324 and the rear surface 328. In some examples, the rounded edge surfaces 327 may extend between and connect each of the pair of lateral surfaces 329A, 329B and the front surface 326, and each of the pair of lateral surfaces 329A, 329B and the rear surface 328.

In the illustrated embodiment of FIGS. 5A-5F, the upper surface 322 includes one or more visual indicia 331. In some embodiments, the one or more visual indicia 331 may be printed on the upper surface 322. In some other embodiments, the one or more visual indicia 331 may be embossed on the upper surface 322. However, in some other embodiments, the one or more visual indicia 331 may be disposed on one or more of the upper surface 322, the lower surface 324, the front surface 326, the rear surface 328, and the lateral surfaces 329A, 329B.

In some other embodiments, the main housing 320 may include a label (not shown). In some embodiments, the one or more visual indicia 331 may be printed or embossed on the label. In some embodiments, the label may cover at least a portion of the upper surface 322. However, in some other embodiments, the label may be disposed on one or more of the upper surface 322, the lower surface 324, the front surface 326, the rear surface 328, and the lateral surfaces 329A, 329B.

In some embodiments, the one or more visual indicia 331 may include letters, words, alphanumerics, symbols, or pictures, or a combination thereof.

In some embodiments, the upper surface 322 includes a first upper portion 322A extending from the rear surface 328 towards the front surface 326 and a second upper portion 322B extending from the front surface 326 towards the first upper portion 322A. In some embodiments, the second upper portion 322B is inclined towards the lower surface 324. The second upper portion 322B is inclined to the first upper portion 322A by a first angle 323A (shown in FIG. 5D). In some embodiments, the first angle 323A is between about 15 degrees and about 45 degrees. However, the first angle 323A may be any angle, as per desired application requirements.

In some embodiments, the upper surface 322 further includes a third upper portion 322C disposed between the first upper portion 322A and the second upper portion 322B. In some embodiments, the third upper portion 322C is inclined towards the lower surface 324. The third upper portion 322C is inclined to the first upper portion 322A by a second angle 323B (shown in FIG. 5D) less than the first angle 323A. In some embodiments, the second angle 323B is between about 5 degrees and about 30 degrees. However, the second angle 323B may be any angle, as per desired application requirements.

In some embodiments, the lower surface 324 includes a first lower portion 324A extending from the rear surface 328 towards the front surface and a second lower portion 324B extending from the front surface 326 towards the rear surface 328. The second lower portion 324B is spaced apart from the first lower portion 324A along the height axis 306.

In some embodiments, the lower surface 324 further includes a third lower portion 324C extending at least partially along the height axis 306 and connecting the first lower portion 324A to the second lower portion 324B. In some embodiments, the third lower portion 324C may extend substantially parallel to the height axis 306. However, in some other embodiments, the third lower portion 324C may be inclined with respect to the height axis 306.

Therefore, the upper surface 322 and the lower surface 324 have respective non-planar shapes that are different from each other. The main housing 320 may therefore be asymmetric (i.e., no plane of symmetry) with respect to a plane parallel to the longitudinal axis 302 and the transverse axis 304, and orthogonal to the height axis 306.

The front surface 326 may have a height 326H (shown in FIG. 5D) measured along the height axis 306. The rear surface 328 may have a height 328H (shown in FIG. 5D) measured along the height axis 306. In some embodiments, the height 328H of the rear surface 328 may be greater than the height 326H of the front surface 326. In some embodiments, the height 328H of the rear surface 328 may be greater than the height 326H of the front surface 326 by a factor of 1.2, 1.4, 1.5, 1.6, 1.8, or 2. The main housing 320 may therefore be asymmetric (i.e., no plane of symmetry) with respect to a plane parallel to the transverse axis 304 and the height axis 306, and orthogonal to the longitudinal axis 302.

In some embodiments, the main housing 320 further includes a plurality of apertures 325 (shown in FIG. 5C) extending therethrough and disposed on the lower surface 324. In some embodiments, the plurality of apertures 325 is disposed on the second lower portion 324B of the lower surface 324. In some embodiments, a battery terminal 325T of the battery pack 300 extends at least partially from each of the plurality of apertures 325. In the illustrated embodiment of FIG. 5C, the main housing 320 includes twelve apertures 325. However, a number of apertures 325 may be varied based on application attributes. For example, the number of apertures 325 may be based on a number of the battery terminals 325T of the battery pack 300. The battery terminals 325T of the battery pack 300 may be used to electrically connect the battery pack 300 to the electronic module 200 (shown in FIG. 3).

Referring to FIGS. 5A-5F, the battery pack 300 further includes at least one projection 330 extending from the rear surface 328 along the longitudinal axis 302. The at least one projection 330 further extends along the transverse axis 304, such that the at least one projection 330 is asymmetrically positioned with respect to the longitudinal plane of symmetry 308 of the main housing 320. Therefore, the at least one projection 330 is asymmetrically positioned on the rear surface 328 with respect to the transverse axis 304. In some embodiments, the at least one projection 330 may be integral with (or made together with) the main housing 320. In some embodiments, the at least one projection 330 may be integral with the rear surface 328. In some embodiments, the at least one projection 330 further includes a plurality of rounded edge surfaces.

In some embodiments, the at least one projection 330 is spaced apart from the upper surface 322 by a first maximum distance 336 (shown in FIG. 5D) measured along the height axis 306. Specifically, the first maximum distance 336 is measured from an intersection between the upper surface 322 and the rear surface 328 to the at least one projection 330 along the height axis 306.

The at least one projection 330 is further spaced apart from the lower surface 324 by a second maximum distance 337 (shown in FIG. 5D) measured along the height axis 306. Specifically, the second maximum distance 337 is measured from an intersection between the lower surface 324 and the rear surface 328 to the at least one projection 330 along the height axis 306. In some embodiments, the first maximum distance 336 is greater than the second maximum distance 337 by a factor of at least 1.5. In some other embodiments, the first maximum distance 336 is greater than the second maximum distance 337 by a factor of at least 1.2, 1.25, 1.45, 1.55, 1.75, 2, 2.25, 2.5, or 2.75. In some embodiments, the first maximum distance 336 and the second maximum distance 337 may be based on a position of the slot 212 (shown in FIG. 3) of the battery receptacle 210 (shown in FIG. 3). The at least one projection 330 is therefore asymmetrically positioned on the rear surface 328 with respect to the height axis 306.

In the illustrated embodiment of FIGS. 5A-5F, the at least one projection 330 includes two projections, i.e., a first projection 332 and a second projection 334. However, in some other embodiments, the at least one projection 330 may include any number of projections, as per desired application attributes.

In the illustrated embodiments of FIGS. 5A-5E, the first projection 332 is proximal to one lateral surface 329A of the pair of lateral surfaces 329A, 329B. The first projection 332 is asymmetrically positioned with respect to the longitudinal plane of symmetry 308 of the main housing 320. The second projection 334 is spaced apart from the first projection 332 along the transverse axis 304 and disposed proximal to the other one lateral surface 329B of the pair of lateral surfaces 329A, 329B. The second projection 334 is asymmetrically positioned with respect to the longitudinal plane of symmetry 308 of the main housing 320.

In some embodiments, the first projection 332 has a first maximum length 338 (shown in FIG. 5F) measured along the transverse axis 304. In some embodiments, the second projection 334 has a second maximum length 339 (shown in FIG. 5F) measured along the transverse axis 304. In some embodiments, the first maximum length 338 is greater than the second maximum length 339 by a factor of at least 1.2. In some embodiments, the first maximum length 338 is greater than the second maximum length 339 by a factor of at least 1.3, 1.4, 1.5, 1.6, 1.7, 1.8, 1.9, or 2.

Therefore, the first and second projections 332, 334 have different dimensions and together provide a degree of asymmetry with respect to the longitudinal plane of symmetry 308. In some embodiments, a distance between the first projection 332 and the proximal lateral surface 329A is different from a distance between the second projection 334 and the proximal lateral surface 329B.

In some embodiments, the first projection 332 intersects with the longitudinal plane of symmetry 308 of the main housing 320 and the second projection 334 is spaced apart from the longitudinal plane of symmetry 308 of the main housing 320. In some other embodiments, each of the first projection 332 and the second projection 334 may be spaced apart from the longitudinal plane of symmetry 308 of the main housing 320.

In some embodiments, the at least one projection 330 has a substantially rectangular cross-sectional shape. In some embodiments, the at least one projection 330 has a shape substantially similar to a shape of the slot 212 (shown in FIG. 3) of the battery receptacle 210 (shown in FIG. 3), such that the at least one projection 330 is at least partially received within the slot 212. In some other examples, the at least one projection 330 has a substantially circular, oval, elliptical, triangular, or polygonal cross-sectional shape.

Referring to FIGS. 5A-5F, the battery pack 300 further includes a lock member 340 disposed on the lower surface 324. In some embodiments, the lock member 340 is disposed on the second lower portion 324B. The lock member 340 extends from the front surface 326 along the height axis 306. The lock member 340 further extends along the longitudinal axis 302. In some embodiments, the lock member 340 may be integral with (or made together with) the main housing 320. In some embodiments, the lock member 340 may be integral with the lower surface 324. In some embodiments, the lock member 340 may be integral with the second lower portion 324B.

The lock member 340 defines a lock slot 342 therein extending along the transverse axis 304, such that the lock slot 342 is asymmetrically positioned with respect to the longitudinal plane of symmetry 308 of the main housing 320. The lock slot 342 is configured to at least partially receive the latch 216 (shown in FIG. 3) of the battery receptacle 210 (shown in FIG. 3) therein. In some embodiments, the lock slot 342 has a substantially rectangular shape. In some other examples, the lock slot 342 has a substantially circular, a substantially oval, a substantially elliptical, a substantially triangular, or a substantially polygonal shape. The shape of the lock slot 342 may be varied, as per desired application attributes. In some examples, the shape of the lock slot 342 may be based on a shape and dimensions of the latch 216. Referring to FIGS. 3 and 5A-5F, in the unlocking position 240 (shown in FIG. 7E) of the latch 216, the latch 216 is disposed outside the lock slot 342 of the lock member 340. Further, in the locking position 230 of the latch 216, the latch 216 is at least partially received within the lock slot 342 of the lock member 340, thereby securing the battery pack 300 to the electronic module 200.

Since the main housing 320 of the battery pack 300 includes the at least one projection 330 and the lock member 340 asymmetrically positioned with respect to the longitudinal plane of symmetry 308 of the main housing 320, the battery pack 300 may be installed in the battery receptacle 210 (shown in FIG. 3) only in an intended direction and position (e.g., an installed configuration 394 shown in FIG. 7D). This may ensure that the battery pack 300 is installed in a correct manner. Further, the personnel using the article of PPE 100 (shown in FIG. 1) may easily identify the intended direction and position to install the battery pack 300 in the battery receptacle 210, and therefore install the battery pack 300 in the battery receptacle 210 in less time than a time required to install conventional battery packs. In some cases, this may also prevent installation of the battery pack 300 in an incorrect manner and may prevent any undesirable outcome that may be due to the installation of the battery pack 300 in the incorrect manner in the hazardous environments.

FIG. 6 is a schematic circuit diagram of the electric circuit 350, according to an embodiment of the present disclosure. As discussed above, in some embodiments, the at least one electrochemical cell 310 includes the pair of electrochemical cells 312, 314. The electrochemical cells 312, 314 of the pair of electrochemical cells 312, 314 are electrically connected in series with each other.

Further, as discussed above the at least one electrochemical cell 310 may include rechargeable cells. The rechargeable cells may be sensitive to the fault conditions, such as overcharging, overdischarging, and/or exposure to excessive current loads. For example, contaminants in the battery pack 300 (shown in FIG. 4), a loose or failed battery pack 300 component, and/or an excess current load may cause an excessive thermal energy condition in the battery pack 300. The excessive thermal energy condition may also migrate to the at least one electrochemical cell 310 of the battery pack 300.

In some embodiments, the electric circuit 350 includes a battery connector 280 electrically connected to one or more components of the electric circuit 350. In the illustrated embodiment of FIG. 6, the battery connector 280 is an 8-pin battery connector. The battery connector 280 may be configured to electrically connect the one or more components of the electric circuit 350 to the one or more components of the electronic module 200 (shown in FIG. 3). In some embodiments, the electric circuit 350 may further include additional battery connectors to connect the at least one electrochemical cell 310 to the electronic module 200.

In some embodiments, the electric circuit 350 includes a fuel gauge integrated circuit (IC) 352 electrically connected to the at least one electrochemical cell 310. In the illustrated embodiment of FIG. 6, the fuel gauge IC 352 is electrically connected to the pair of electrochemical cells 312, 314.

The fuel gauge IC 352 may determine and monitor various parameters related to the at least one electrochemical cell 310. For example, the various parameters may be related to health of the at least one electrochemical cell 310, cell voltage of the at least one electrochemical cell 310, temperature of the at least one electrochemical cell 310, cell capacity of the at least one electrochemical cell 310, a state of charge (SOC) of the at least one electrochemical cell 310, current flowing in and/or out of the at least one electrochemical cell 310, etc. The fuel gauge IC 352 may employ any of a variety of techniques to measure the current flowing in and/or out of the at least one electrochemical cell 310. In some embodiments, the fuel gauge IC 352 may determine when one of the at least one electrochemical cell 310 is damaged and may bypass the one of the at least one electrochemical cell 310. This may prevent the excessive thermal energy condition and improve the intrinsic safety of the battery pack 300 (shown in FIG. 4). In some embodiments, the fuel gauge IC 352 may include MAX17205 commercially available from Maxim Integrated Products, Sunnyvale, Calif.

In some embodiments, the fuel gauge IC 352 includes communication pins 360. The communication pins 360 may be Inter-Integrated Circuit (12C) pins of the fuel gauge IC 352. The fuel gauge IC 352 may communicate with the one or more components, such as the one or more processors, of the electronic module 200 (shown in FIG. 3) via the battery connector 280 to indicate the state of charge of the at least one electrochemical cell 310 and/or the battery level of the battery pack 300 (shown in FIG. 4) and communicate other types of information relating to the battery pack 300 to the electronic module 200 (shown in FIG. 3) via the communication pins 360. The one or more components, such as the one or more processors of the electronic module 200 may create a graphical representation of the state of charge and/or the battery level and a remaining battery-operating time of the battery pack 300.

In some embodiments, the electric circuit 350 further includes at least one thermistor 354 thermally coupled to the at least one electrochemical cell 310 and electrically connected to the fuel gauge IC 352. In the illustrated embodiment of FIG. 6, the at least one thermistor 354 includes a first thermistor 354A and a second thermistor 354B. The first thermistor 354A and the second thermistor 354B are thermally coupled to the respective electrochemical cells 312, 314 of the pair of electrochemical cells 312, 314. Specifically, the first thermistor 354A is thermally coupled to the electrochemical cell 312, while the second thermistor 354Bis thermally coupled to the electrochemical cell 314. The first thermistor 354A and the second thermistor 354B are used to determine individual temperatures of the respective electrochemical cells 312, 314.

In some embodiments, the electric circuit 350 further includes at least one resistor-fuse combination 356 electrically disposed in series between the at least one electrochemical cell 310 and the fuel gauge IC 352. Specifically, the electric circuit 350 further includes the at least one resistor-fuse combination 356 electrically disposed in series between the at least one electrochemical cell 310 and each voltage pin 357 of the fuel gauge IC 352. The fuel gauge IC 352 includes two voltage pins 357. The voltage pins 357 of the fuel gauge IC 352 may help to determine individual voltages of the at least one electrochemical cell 310 as well as a combined voltage of the at least one electrochemical cell 310 (e.g., the pair of electrochemical cells 312, 314).

In the illustrated embodiment of FIG. 6, the at least one resistor-fuse combination 356 includes two resistor-fuse combinations 356. One of the two resistor-fuse combinations 356 is electrically disposed in series between the electrochemical cell 312 of the pair of electrochemical cells 312, 314 and the fuel gauge IC 352, and the other of the two resistor-fuse combinations 356 is electrically disposed in series between the electrochemical cell 314 of the pair of electrochemical cells 312, 314 and the fuel gauge IC 352. The resistor-fuse combinations 356 may limit and/or open to interrupt a current flow in case of the fault conditions, such as in an event of an overcurrent and/or the excessive thermal energy condition. This may further improve the intrinsic safety of the battery pack 300 (shown in FIG. 4).

In some embodiments, the electric circuit 350 further includes a pair of shunt diodes 362 disposed in parallel to each other and electrically connected to each communication pin 360 of the fuel gauge IC 352. For example, the fuel gauge IC 352 includes two communication pins 360. Therefore, the electric circuit 350 further includes two of the pair of shunt diodes 362. Each of the two communication pins 360 is electrically connected to one of the two pairs of shunt diodes 362. In some embodiments, the pair of shunt diodes 362 disposed in parallel to each other and electrically connected to the corresponding communication pin 360 of the fuel gauge IC 352 may limit a voltage to a predetermined maximum voltage on the corresponding communication pin 360 and protect the fuel gauge IC 352 in case of the fault conditions, such as in an event of an overvoltage condition due to a fault in the one or more components of the electronic module 200 electrically connected to the electric circuit 350. This may further improve the intrinsic safety of the battery pack 300 (shown in FIG. 4). In some embodiments, each of the shunt diodes 362 is a Zener diode.

In some embodiments, the pair of shunt diodes 362 may increase an overall bus capacitance and may negatively impact a clock signal and communication between the one or more components of the electronic module 200 and the fuel gauge IC 352 via the communication pins 360. In some embodiments, to counter this, an I2C accelerator IC (not shown) may be used that may improve the clock signal thereby negating the increase of the overall bus capacitance.

In some embodiments, the electric circuit 350 further includes a plurality of resistors 364 disposed in series to each other and electrically connected to each communication pin 360 of the fuel gauge IC 352. For example, as discussed above, the fuel gauge IC 352 includes two communication pins 360. Therefore, the electric circuit 350 further includes two sets of the plurality of resistors 364. Each of the two communication pins 360 is electrically connected to one of the two sets of the plurality of resistors 364. In a further example, the plurality of resistors 364 include a plurality of first resistors 364A disposed in series to each other and electrically connected to one communication pin 360 of the fuel gauge IC 352 and a plurality of second resistors 364B disposed in series to each other and electrically connected to one other communication pin 360 of the fuel gauge IC 352. In some embodiments, the plurality of resistors 364 disposed in series to each other and electrically connected to each communication pin may protect the fuel gauge IC 352 by limiting power to the fuel gauge IC 352 from the one or more components of the electronic module 200 in case of the fault condition. This may further improve the intrinsic safety of the battery pack 300 (shown in FIG. 4).

In some embodiments, the electric circuit 350 further includes a charger IC 358 electrically connected to the at least one electrochemical cell 310. In some other embodiments, the charger IC 358 may be electrically connected to the at least one electrochemical cell 310 and may be located in the electronic module 200 (shown in FIG. 3), or any other component of the article of PPE (shown in FIG. 1). The charger IC 358 is configured to receive electrical power from an external power source, such as a recharging device and supply an electric current to the at least one electrochemical cell 310.

In some embodiments, the charger IC 358 is a linear charger. Therefore, any energy storage elements, such as inductors, may not be present in the electric circuit 350. This may further improve the intrinsic safety of the battery pack 300 (shown in FIG. 4). In some embodiments, the charger IC 358 may include BQ24005 commercially available from Texas Instruments™ of Dallas, Tex.

In some embodiments, the electric circuit 350 further includes a plurality of blocking diodes 359 electrically disposed in series between the charger IC 358 and the at least one electrochemical cell 310. Each of the plurality of blocking diodes 359 allows flow of electric current from the charger IC 358 to the at least one electrochemical cell 310. In the illustrated embodiment of FIG. 6, the plurality of blocking diodes 359 is electrically disposed in series between an output of the charger IC 358 and the electrochemical cell 314. The plurality of blocking diodes 359 may prevent discharging of the at least one electrochemical cell 310 in case of the fault condition and may prevent the charger IC 358 from the excessive thermal energy condition. Therefore, the plurality of blocking diodes 359 may further improve the intrinsic safety of the battery pack 300 (shown in FIG. 4). In some embodiments, the charger IC 358 may include a sense pin 384 to compensate for a drop in voltage due to the plurality of blocking diodes 359 and to charge the at least one electrochemical cell 310 efficiently without any drops in voltage due to the plurality of blocking diodes 359.

In some embodiments, the electric circuit 350 further includes a central thermistor 354C disposed in a central region between the pair of electrochemical cells 312, 314 and electrically connected to the charger IC 358. The central thermistor 354C may be used to determine a temperature of the central region. In some embodiments, the charger IC 358 may control charging of the pair of electrochemical cells 312, 314 based on the temperature of the central region. For example, the charger IC 358 may stop charging of the pair of electrochemical cells 312, 314 when the temperature of the central region exceeds a predetermined temperature threshold, such as in the excessive thermal energy condition. This may further improve the intrinsic safety of the battery pack 300 (shown in FIG. 4).

In some embodiments, the charger IC 358 may include one or more status pins 384. In the illustrated embodiment of FIG. 6, one status pin 384 is shown. The status pin 384 may be used to drive an output device 388 for providing a charging status indication. In the illustrated embodiment of FIG. 6, the output device is a light emitting diode (LED). However, the output device 388 may also include speakers, etc., for providing the charging status indication. In some embodiments, the one or more status pins may interface with the one or more components of the electronic module 200 via the battery connector 280.

In some embodiments, the electric circuit 350 further includes a jumper 382. Specifically, the electric circuit 350 includes the jumper 382 when the at least one electrochemical cell is the at least one secondary or rechargeable cell. The jumper 382 is configured to route the electrical power received from the external power source to the charger IC 358.

As discussed above, in some other embodiments, the at least one electrochemical cell 310 may be the at least one primary cell. In some cases, the electrical power from the external power source may leak into the at least one primary cell due to fault conditions, such as a component failure of the recharging device. This may be detrimental to the intrinsic safety of the battery pack 300. The electric circuit 350 for the battery pack 300 including the at least one primary cell does not include the jumper 382. Therefore, the charger IC 358 may not receive any electrical power from the external power source as the electric circuit 350 of the battery pack 300 including the at least one primary cell does not include the jumper 382. This may prevent the electrical power from the external power source from leaking into the at least one primary cell in the fault conditions via the charger IC 358.

In some embodiments, the electric circuit 350 further includes a protection IC 366 electrically connected to the at least one electrochemical cell 310. In some embodiments, the protection IC 366 may include S-8252AAX commercially available from ABLIC Inc., Chiba-shi, Japan.

In some embodiments, the electric circuit 350 further includes at least one resistor 367 electrically disposed between the at least one electrochemical cell 310 and the protection IC 366. In some embodiments, the at least one resistor 367 is electrically disposed between the at least one electrochemical cell 310 and each of voltage pins 368 of the protection IC 366. The at least one resistor 367 may limit a current flow in case of the fault condition. The protection IC 366 may provide protection to the at least one electrochemical cell 310 in case of the fault condition and prevent overcharging, overdischarging, short-circuit, charge overcurrent, discharge overcurrent, etc., of the at least one electrochemical cell 310.

In some embodiments, the protection IC 366 may determine current consumption by the electric circuit 350 and, if the current consumption by the electric circuit 350 exceeds a predetermined threshold, may interrupt the current flow to the electric circuit 350. The protection IC 366 may interrupt the current flow from either the at least one electrochemical cell 310 and/or the external power source, thereby substantially preventing or eliminating an excessive current flow through the electric circuit 350 which may otherwise cause the excessive thermal energy condition. In some embodiments, the protection IC 366 is electrically connected to serially-connected charge/discharge metallic oxide semiconductor field effect transistors (MOSFETs) 370, to control the current flow in and/or out of the at least one electrochemical cell 310.

Thus, the electric circuit 350 may prevent the excessive thermal energy conditions in case of the fault conditions. Further, the electric circuit 350 may improve the intrinsic safety of the battery pack 300.

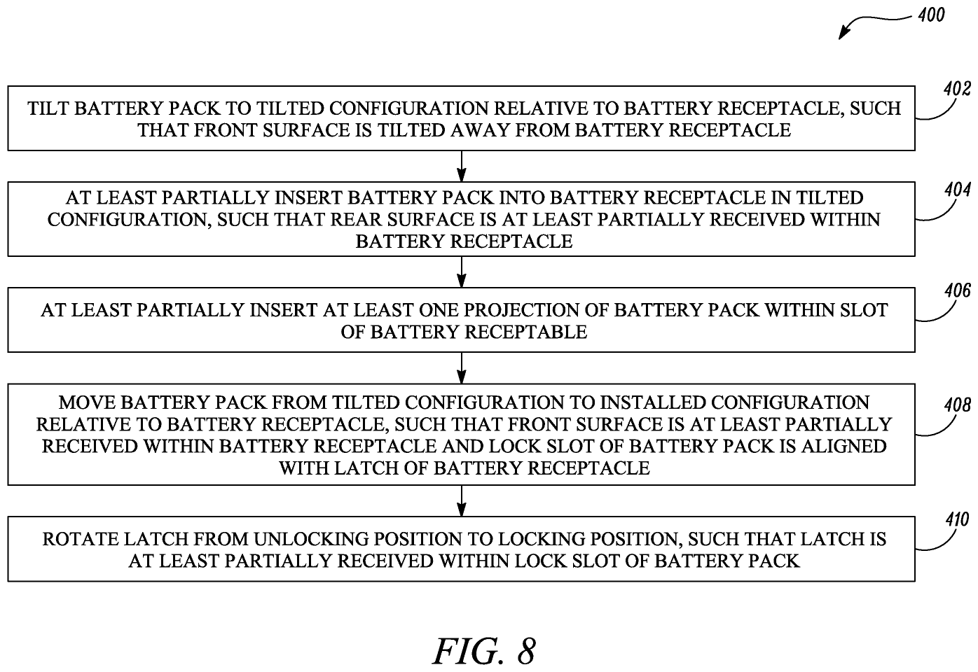

FIGS. 7A-7G illustrate various steps of using the electronic system 150, according to an embodiment of the present disclosure. FIG. 8 illustrates a flowchart depicting a method 400 of using the electronic system 150, according to an embodiment of the present disclosure. The method 400 will be described with reference to FIGS. 7A-7G, and 8.

At step 402, the method 400 includes tilting the battery pack 300 to a tilted configuration 392 relative to the battery receptacle 210, such that the front surface 326 is tilted away from the battery receptacle 210 (as shown in FIG. 7A).

At step 404, the method 400 includes at least partially inserting the battery pack 300 into the battery receptacle 210 in the tilted configuration 392, such that the rear surface 328 is at least partially received within the battery receptacle 210 (as shown in FIG. 7B). At step 406, the method 400 includes at least partially inserting the at least one projection 330 of the battery pack 300 within the slot 212 of the battery receptacle 210 (as shown in FIG. 7C)

At step 408, the method 400 includes moving the battery pack 300 from the tilted configuration 392 to the installed configuration 394 relative to the battery receptacle 210, such that the front surface 326 is at least partially received within the battery receptacle 210 (as shown in FIG. 7D) and the lock slot 342 of the battery pack 300 is aligned with the latch 216 (shown in FIG. 3) of the battery receptacle 210 (as shown in FIG. 7D). In the installed configuration 394, the lower surface 324 may rest on the battery receptacle 210.

At step 410, the method 400 includes rotating the latch 216 from the unlocking position 240 to the locking position 230, such that the latch 216 is at least partially received within the lock slot 342 of the battery pack 300 (as shown in FIGS. 7E-7G). The lower surface 324 is not shown in FIGS. 7E and 7G for illustrative purposes.

Therefore, the latch 216 may secure the battery pack 300 to the electronic module 200. In some embodiments, rotating the latch 216 includes rotating the rotatable member 218 via the tool. The tool may engage with the at least one tool groove 222 for rotating the rotatable member 218.

In some embodiments, the method 400 further includes rotating the latch 216 from the locking position 230 to the unlocking position 240, such that the latch 216 is disposed outside the lock slot 342 of the battery pack 300. In some embodiments, rotating the latch 216 from the locking position 230 to the unlocking position 240 includes rotating the rotatable member 218 via the tool. In some embodiments, the method 400 further includes moving the battery pack 300 from the installed configuration 394 to the tilted configuration 392 relative to the battery receptacle 210. In some embodiments, the method 400 further includes removing the battery pack 300 from the battery receptacle 210 in the tilted configuration 392. Since the tool is required for rotating the latch 216 from the locking position 230 to the unlocking position 240, this may reduce a risk of accidental removal of the battery pack 300 from the battery receptacle 210 in the hazardous environments.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

What is claimed is:

1. A battery pack configured to be removably received within a battery receptacle of an electronic module, the battery pack comprising:
at least one electrochemical cell;
a main housing receiving the at least one electrochemical cell therein, the main housing comprising an upper surface, a lower surface opposite to the upper surface, a front surface extending between the upper surface and the lower surface, a rear surface opposite to the front surface and extending between the upper surface and the lower surface, and a pair of lateral surfaces opposite to each other and extending between the upper surface and the lower surface, each of the lateral surfaces further extending between the front surface and the rear surface, the main housing defining a longitudinal axis extending between the front surface and the rear surface, a transverse axis orthogonal to the longitudinal axis and extending between the pair of lateral surfaces, a height axis extending between the upper surface and the lower surface and orthogonal to each of the longitudinal axis and the transverse axis, and a longitudinal plane of symmetry extending between the front surface and the rear surface and disposed parallel to each of the longitudinal axis and the height axis;
at least one projection extending from the rear surface along the longitudinal axis, the at least one projection further extending along the transverse axis, such that the at least one projection is asymmetrically positioned with respect to the longitudinal plane of symmetry of the main housing, wherein the at least one projection is configured to be at least partially received within a slot of the battery receptacle; and
a lock member disposed on the lower surface and extending from the front surface along the height axis, the lock member further extending along the longitudinal axis, the lock member defining a lock slot therein extending along the transverse axis, such that the lock slot is asymmetrically positioned with respect to the longitudinal plane of symmetry of the main housing, wherein the lock slot is configured to at least partially receive a latch of the battery receptacle therein.

2. The battery pack of claim 1, wherein the at least one projection is spaced apart from the upper surface by a first maximum distance measured along the height axis, wherein the at least one projection is further spaced apart from the lower surface by a second maximum distance measured along the height axis, and wherein the first maximum distance is greater than the second maximum distance by a factor of at least 1.5.

3. The battery pack of claim 1, wherein the at least one projection comprises:
a first projection proximal to one of the pair of lateral surfaces, wherein the first projection is asymmetrically positioned with respect to the longitudinal plane of symmetry of the main housing; and
a second projection spaced apart from the first projection along the transverse axis and disposed proximal to the other one of the pair of lateral surfaces, wherein the second projection is asymmetrically positioned with respect to the longitudinal plane of symmetry of the main housing.

4. The battery pack of claim 3, wherein the first projection has a first maximum length measured along the transverse axis, wherein the second projection has a second maximum length measured along the transverse axis, and wherein the first maximum length is greater than the second maximum length by a factor of at least 1.2.

5. The battery pack of claim 3, wherein the first projection intersects with the longitudinal plane of symmetry of the main housing, and wherein the second projection is spaced apart from the longitudinal plane of symmetry of the main housing.

6. The battery pack of claim 1, wherein the at least one projection has a substantially rectangular cross-sectional shape.

7. (canceled)

8. The battery pack of claim 1, wherein the upper surface comprises a first upper portion extending from the rear surface towards the front surface and a second upper portion extending from the front surface towards the first upper portion, wherein the second upper portion is inclined to the first upper portion by a first angle.

9. The battery pack of claim 8, wherein the upper surface further comprises a third upper portion disposed between the first upper portion and the second upper portion, and wherein the third upper portion is inclined to the first upper portion by a second angle less than the first angle.

10. The battery pack of claim 1, wherein the lower surface comprises:
a first lower portion extending from the rear surface towards the front surface;
a second lower portion extending from the front surface towards the rear surface, wherein the second lower portion is spaced apart from the first lower portion along the height axis, and wherein the lock member is disposed on the second lower portion; and
a third lower portion extending at least partially along the height axis and connecting the first lower portion to the second lower portion.

11. The battery pack of claim 10, wherein the main housing further comprises a plurality of apertures extending therethrough and disposed on the second lower portion of the lower surface.

12. (canceled)

13. The battery pack of claim 1, further comprising an electric circuit received within the main housing, the electric circuit comprising:
a fuel gauge integrated circuit (IC) electrically connected to the at least one electrochemical cell;
at least one thermistor thermally coupled to the at least one electrochemical cell and electrically connected to the fuel gauge IC; and
at least one resistor-fuse combination electrically disposed in series between the at least one electrochemical cell and the fuel gauge IC.

14. The battery pack of claim 13, wherein the electric circuit further comprises:
a charger IC electrically connected to the at least one electrochemical cell; and
a plurality of blocking diodes electrically disposed in series between the charger IC and the at least one electrochemical cell, wherein each of the plurality of blocking diodes allows flow of electric current from the charger IC to the at least one electrochemical cell.

15. The battery pack of claim 13, wherein the electric circuit further comprises a pair of shunt diodes disposed in parallel to each other and electrically connected to each communication pin of the fuel gauge IC.

16. The battery pack of claim 13, wherein the electric circuit further comprises a plurality of resistors disposed in series to each other and electrically connected to each communication pin of the fuel gauge IC.

17. The battery pack of claim 13, wherein the electric circuit further comprises a protection IC electrically connected to the at least one electrochemical cell.

18. The battery pack of claim 13, wherein the at least one electrochemical cell comprises a pair of electrochemical cells electrically connected in series with each other.

19. The battery pack of claim 18, wherein the electric circuit further comprises a charger IC and a central thermistor disposed between the pair of electrochemical cells and electrically connected to the charger IC.

20. The battery pack of claim 13, wherein the electric circuit further comprises:
a charger IC electrically connected to the at least one electrochemical cell, wherein the at least one electrochemical cell is at least one rechargeable cell, and wherein the charger IC is configured to receive electrical power from an external power source and supply the electrical power to the at least one electrochemical cell; and
a jumper configured to route the electrical power received from the external power source to the charger IC.

21. An electronic system comprising:
an electronic module comprising a battery receptacle comprising a slot, a stationary member, and a latch rotatably coupled to the stationary member, wherein the latch is rotatable relative to the stationary member between a locking position and an unlocking position; and
a battery pack configured to be removably received within the battery receptacle of the electronic module, the battery pack comprising:
at least one electrochemical cell;
a main housing receiving the at least one electrochemical cell therein, the main housing comprising an upper surface, a lower surface opposite to the upper surface, a front surface extending between the upper surface and the lower surface, a rear surface opposite to the front surface and extending between the upper surface and the lower surface, and a pair of lateral surfaces opposite to each other and extending between the upper surface and the lower surface, each of the lateral surfaces further extending between the front surface and the rear surface, the main housing defining a longitudinal axis extending between the front surface and the rear surface, a transverse axis orthogonal to the longitudinal axis and extending between the pair of lateral surfaces, a height axis extending between the upper surface and the lower surface and orthogonal to each of the longitudinal axis and the transverse axis, and a longitudinal plane of symmetry extending between the front surface and the rear surface and disposed parallel to each of the longitudinal axis and the height axis;
at least one projection extending from the rear surface along the longitudinal axis, the at least one projection further extending along the transverse axis, such that the at least one projection is asymmetrically positioned with respect to the longitudinal plane of symmetry of the main housing, wherein the at least one projection is configured to be at least partially received within the slot of the battery receptacle; and
a lock member disposed on the lower surface and extending from the front surface along the height axis, the lock member further extending along the longitudinal axis, the lock member defining a lock slot therein extending along the transverse axis, such that the lock slot is asymmetrically positioned with respect to the longitudinal plane of symmetry of the main housing, wherein the lock slot is configured to at least partially receive the latch of the battery receptacle therein;
wherein, in the unlocking position of the latch, the latch is disposed outside the lock slot of the lock member, and wherein, in the locking position of the latch, the latch is at least partially received within the lock slot of the lock member, thereby securing the battery pack to the electronic module.

22-42. (canceled)

43. An article of personal protective equipment (PPE) comprising:
an air cylinder comprising breathable air;
a back frame configured to support the air cylinder on a back of a user;
a facemask arranged to provide the breathable air from the air cylinder to the user;
a regulator in fluid communication with the air cylinder and configured to control a supply of the breathable air to the facemask; and
the electronic system of claim 21 mounted on the back frame.

44-45. (canceled)
